(19) United States
(12) Patent Application Publication
(10) Pub. No.: US 2011/0168855 A1
(43) Pub. Date: Jul. 14, 2011

(54) Rotating Mounting Assembly

(76) Inventors: Michael Francis Bonczyk, McAllen, TX (US); Troy Vanderhoof, McKinney, TX (US); Philip Sorrells, Corinth, TX (US)

(21) Appl. No.: 12/781,101

(22) Filed: May 17, 2010

Related U.S. Application Data
(60) Provisional application No. 61/178,693, filed on May 15, 2009.

(51) Int. Cl. E05D 3/06; F16M 13/00

(52) U.S. Cl. 248/201; 16/368; 248/284.1

(57) ABSTRACT

A rotating mounting assembly comprising an extension member and a downtilt member having hinge tabs that form a plurality of revolving nutplate hinges. The plurality of nutplate hinges coupling the extension member to the downtilt member such that the downtilt member rotates about the nutplate hinges relative to the extension member. The hinge tabs having a plurality of apertures. Coaxial alignment of apertures on an extension hinge tab with apertures on a downtilt hinge tab forming a plurality of adjustment features. Adjacent apertures on the extension hinge tabs having a different spacing than adjacent apertures on the downtilt hinge tabs in order to provide a series of highly-acute settings along the angular rotation of the assembly.

### CROSS REFERENCE TO RELATED APPLICATION

This application claims the benefit of U.S. Provisional Application Ser. No. 61/178,693 filed May 15, 2009 entitled “Revolving Shutter Mechanical Downtilt Mechanism.” The entirety of this application is incorporated by reference as if fully set forth herein.

### FIELD OF THE INVENTION

Embodiments of the subject invention are directed to a rotating mounting assembly, and more particularly to a downward tilting mounting assembly having multiple highly-discrete adjustment settings to allow maximum angular resolution across the range of rotation.

### BACKGROUND OF THE INVENTION

Wireless mobile communication networks continue to evolve given the increased traffic demands on the networks, the expanded coverage areas for service and the new systems being deployed. Typically, cellular type communication systems generally consist of a plurality of antenna systems, each serving a sector or area commonly referred to as a cell. These systems are implemented to effect coverage for a larger service area, and the collective cells make up the total service area for a particular wireless communication network.

Cellular (“wireless”) communications networks rely on a network of antennas for connecting cellular devices, such as cellular telephones, to the wireless network. To insure that the cellular communications network has continuous coverage over a geographic area, the antennas structures are widely dispersed throughout various regions. Some antennas structures must be mounted to a mast, tower, or pole that is free standing, while other antennas structures may be mounted to a mast that is attached to a side of building or similar structure. In addition, it is sometimes necessary to increase the height of the antenna due to the construction of new structures, or to add additional antennas to an existing structure. Currently, cellular antennas towers can be connected to support structures, such as masts or buildings using conventional mounting brackets that are well known in the art. Mounting brackets can facilitate mounting to cylindrical surfaces or planar surfaces by a universal mounting assembly such as disclosed in U.S. Pat. No. 7,339,549 assigned to the assignee of the present application hereof and incorporated herein by reference as if set forth in full herein.

It is generally known that greater antenna transmission efficiency can be achieved by tilting the beam of the antenna downward. Downward tilting of the beam of an antenna used in a conventional cellular antenna assembly has been achieved by mounting the antenna at an angle to the support structure. Conventional downward-tilt mounting assemblies have several limitations. Due to the adjustable nature of conventional downward-tilt mounting assemblies, downward tilting flange size is increased compared to non-downward-tilt mounting assemblies. In addition, certain conventional downward-tilt mounting assemblies utilize a continuous downtilt resolution, making it difficult to adjust the bracket to a specific, precise downward title angle. Conversely, other conventional downward-tilt mounting assemblies utilize restricted downtilt settings that provide only limited angular resolution. In a desire to increase angular resolution, conventional downward-tilt mounting assemblies typically employ complex adjustment mechanisms that increase assembly size and cost.

There is, accordingly, a continuous need for an inexpensive downward-tilting mounting assembly that can provide improved angular resolution without having to incorporate an oversized flange or having to compromise flange strength.

### SUMMARY OF THE INVENTION

Embodiments of the subject invention meet the needs described above by providing a rotating mounting assembly having multiple highly-discrete adjustment settings to allow maximum resolution across the range of angular rotation. Generally described, the rotating mounting assembly features an extension member, a downtilt member and a plurality of nutplate hinges coupling the extension member to the downtilt member such that the downtilt member rotates about the nutplate hinges relative to the extension member.

The extension member and downtilt member may be formed by opposing flanges having an inside surface, an outside surface, and a proximal and distal end. Each of the extension and downtilt flanges may further have a hinge tab at their distal end. The hinge tabs of both the extension flanges and downtilt flanges may each have an axis point and a plurality of apertures uniformly spaced from one another around at least a portion of the axis point. Each of the plurality of apertures on a hinge tab being spaced from the axis point of the respective hinge tab may be at a substantially equal radial distance. Adjacent apertures on a hinge tab may be spaced from one another at an angle relative the axis point. The angle between adjacent apertures on the downtilt flange may be different from the angle between adjacent apertures on the extension flange.

The hinge tabs of the extension member and the downtilt member may form the plurality of revolving nutplate hinges. Each nutplate hinge may be formed by one hinge tab extending from the distal end of an extension flange and one hinge tab extending from the distal end of a downtilt flange such that the axis point of the extension flange hinge tab is co-axial the axis point of the downtilt flange hinge tab. Each nutplate hinge may have a plurality of adjustment features formed by rotating the downtilt member to co-axially align an aperture on the extension flange hinge tab with an aperture on the downtilt flange hinge tab. The plurality of adjustment features may be suitable for accepting a fastener for securing the revolving nutplate hinge in a fixed position.

Embodiments of the subject invention provide a high degree of acute downtilt resolution using a minimal number of adjustment features. This highly-acute downtilt resolution is accomplished, at least in part, by the difference in spacing between the apertures on the extension flange hinge tab and the spacing between apertures on the downtilt flange hinge tab. Specifically, the apertures on the downtilt flange hinge tab are spaced apart from one another at a distance that is different than the apertures on the extension flange hinge tab. This difference enables various adjustment features to be formed by only slight rotational movement of the downtilt member relative the extension member. As a result of this arrangement, the mounting assembly can be adjusted to any one of a plurality of highly-discrete positions across the range of angular rotation. This unique configuration provides maximum angular resolution and highly-precise downtilt positioning of an associated antenna assembly.

The unique arrangement of adjustment features of the nutplate hinge further minimizes flange size of the mounting assembly because the adjustment features are confined to the hinge tabs of the extension and downtilt flanges. This arrangement can further minimize the impact to downtilt flange strength. Accordingly, embodiments of the subject invention provide a stronger, less bulky and less expensive means of adjustably supporting an antenna assembly in a plurality of downward tilting positions.

Further objects, features and advantages of the present invention will be apparent from the following description and the appended claims when taken in conjunction with the accompanying drawings.

### BRIEF DESCRIPTION OF THE DRAWINGS

FIG. 1 is a perspective view of an antenna assembly affixed to a mounting surface by a rotating mounting assembly according to various embodiments.

FIG. 1A is an enlarged perspective view of the rotating mounting assembly shown in FIG. 1.

FIG. 2 is an alternate perspective view of a rotating mounting assembly showing the hinge tabs unsecured.

FIG. 3A is an enlarged perspective view showing unsecured hinge tabs of a rotating mounting assembly.

FIG. 3B is an enlarged perspective view showing unsecured hinge tabs of a rotating mounting assembly.

FIG. 3C is a perspective view of a rotating mounting assembly according to various embodiments.

FIG. 4A is a side elevational view of an antenna assembly affixed to a mounting surface by a rotating mounting in a closed position.

FIG. 4B is a side elevational view of an antenna assembly affixed to a mounting surface by a rotating mounting in an open position.

FIG. 5 is a side elevational view of an antenna assembly and rotating mounting assembly having an alternative mounting arrangement according to various embodiments.

### DETAILED DESCRIPTION

While the present invention is susceptible of embodiment in various forms, there is shown in the drawings a number of illustrative embodiments that are discussed in greater detail hereafter. It should be understood that the present disclosure is to be considered as an exemplification of the present invention, and is not intended to limit the invention to the specific embodiments illustrated. It should be further understood that the title of this section of this application (“Detailed Description”) relates to a requirement of the United States Patent Office, and should not be found to limit the subject matter disclosed herein.

In this disclosure, the use of the disjunctive is intended to include the conjunctive. The use of the definite article or indefinite article is not intended to indicate cardinality. In particular, a reference to “the” object or “a” object is intended to denote also one of a possible plurality of such objects.

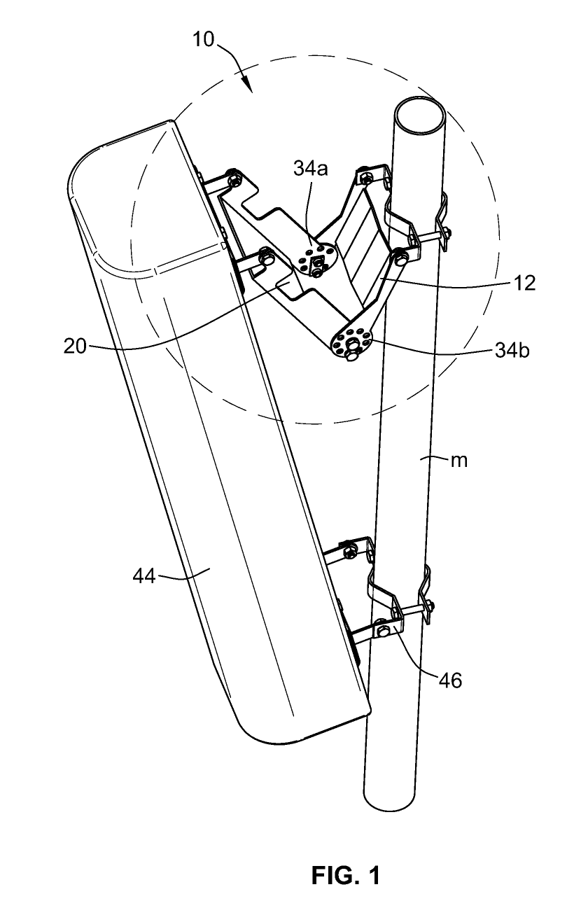

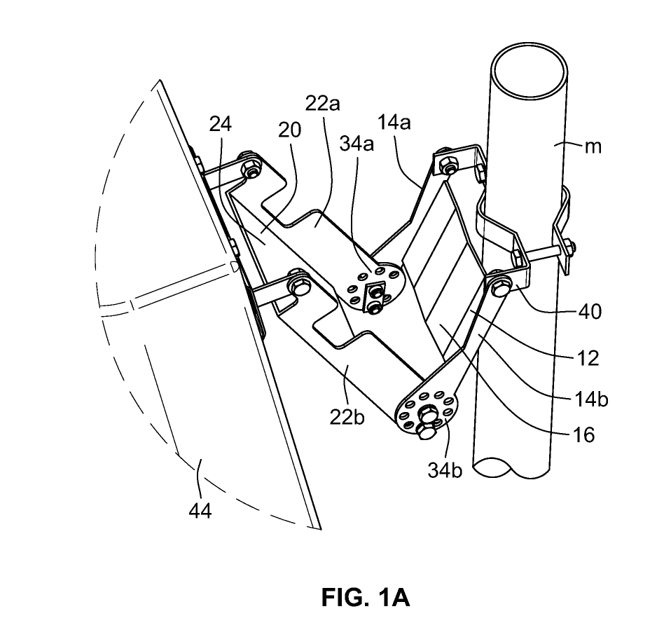

Referring now to the figures, and specifically to FIGS. 1-3, there is shown a rotating mounting assembly 10 having an extension member 12, a downtilt member 20 and a plurality of revolving nutplate hinges 34a, 34b. The plurality of nutplate hinges 34a, 34b coupling the extension member 12 to the downtilt member 20 such that the downtilt member 20 rotates about the nutplate hinges 34a, 34b relative to the extension member 12. The downtilt member 20 being capable of rotating 180 degrees about the revolving nutplate hinges 34a, 34b relative the extension member 12.

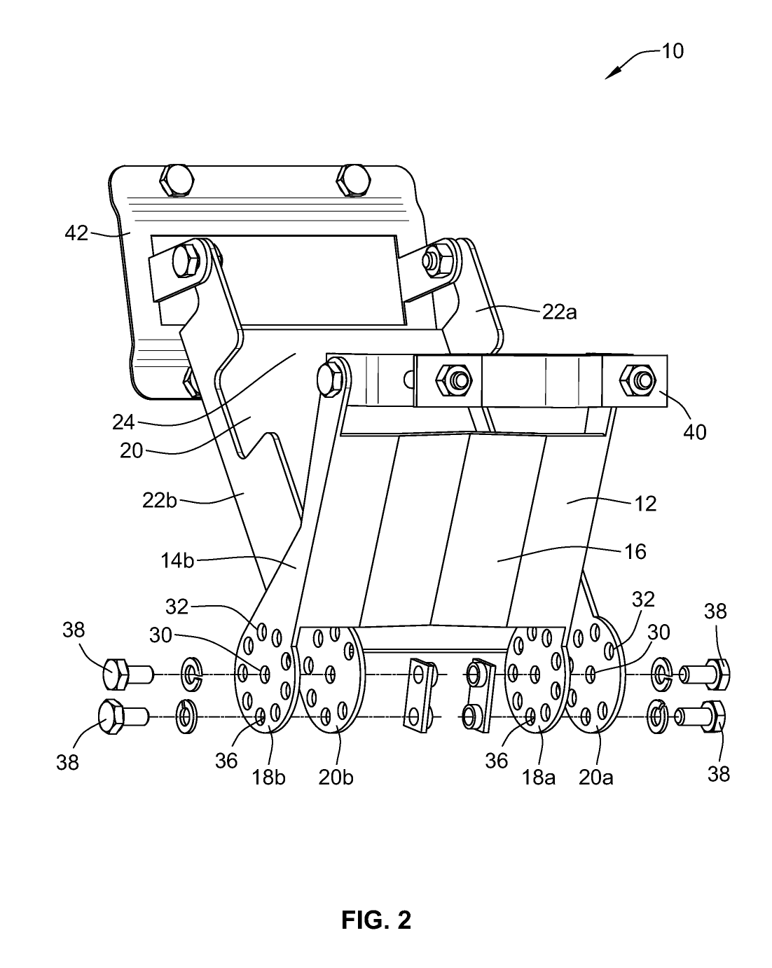

The extension member 12, according to various embodiments, is formed by two opposing extension flanges 14a, 14b. The extension flanges 14a, 14b have an inside surface, an outside surface, and a proximal and distal end. The extension flanges 14a, 14b can additionally be arranged such that they are substantially parallel to one another. According to various embodiments, the extension member 12 can feature a back plate 16 extending substantially perpendicular between the extension flanges 14a, 14b. The distal end of each extension flange 14a, 14b having a hinge tab 18a, 18b. While the extension flange hinge tabs 18a, 18b are shown in FIGS. 1-2 to have a generally-circular shape, they can posses alternative shapes as desired. Moreover, it will be understood by persons having ordinary skill in the art that, while various parts shown in the figures have been described and illustrated as having certain shapes and configurations, these descriptions and illustrations are merely given for ease of understanding, and that various alternative shapes, sizes and proportions can be interchanged without departing from the novel scope of the present invention.

FIG. 1A and FIG. 2 further show the downtilt member 20 formed by two opposing downtilt flanges 22a, 22b. Each downtilt flange 22a, 22b having an inside surface, an outside surface, and a proximal and distal end. The downtilt flanges 22a, 22b can be arranged to be substantially parallel to one another, or can be alternatively arranged as desired. The distal end of each of each downtilt flange 22a, 22b features a hinge tab 26a, 26b. The downtilt member 20 can also feature a support plate 24 extending substantially perpendicular between the downtilt flanges 22a, 22b.

The mounting assembly 10 can feature a mounting bracket 40 suitable for affixing the rotating mounting assembly 10 to a mounting surface m. The mounting bracket 40 is affixed to the rotating mounting assembly 10 at the proximal end of each extension flange 14a, 14b, and is adapted to affix the mounting assembly 10 to any kind of surface, including, for example, cylindrical or planar structures. The mounting assembly 10 can additionally feature an antenna bracket 42 affixed to the proximal end of the downtilt flanges 22a, 22b. The antenna bracket 42 adapted to fasten an antenna assembly 44 to the rotating mounting assembly 10.

As shown in FIG. 1, various embodiments are directed to an antenna mounting apparatus featuring a rotating mounting assembly 10, an antenna assembly 44 suitable for transmitting or receiving electromagnetic signals, and a hinged support bracket 46. The antenna assembly 44 may have a generally elongated body with a first and second end. An antenna bracket 42 of the mounting assembly 10 may be affixed to a point proximate the first end of the antenna assembly 44 and the hinged support bracket 46 being affixed proximate the second end of the antenna assembly 44 and suitable for securing the second end of the antenna assembly 44 to the mounting surface m.

Thus, as the downtilt member 20 of the mounting assembly 10 rotates away from the extension member 12, the first end of the antenna assembly 44 extends away from the mounting surface m, and the antenna assembly 44 tilts at an angle relative the mounting surface m. In addition, the hinged support bracket 46 has a hinged connection that enables the second end of the antenna assembly 44 to pivot away from the mounting surface. It is further contemplated that the antenna mounting assembly can incorporate multiple rotating mounting assemblies 10 and multiple hinged support brackets 46 under certain conditions, such as for example, where an oversized antenna assembly 44 is required.

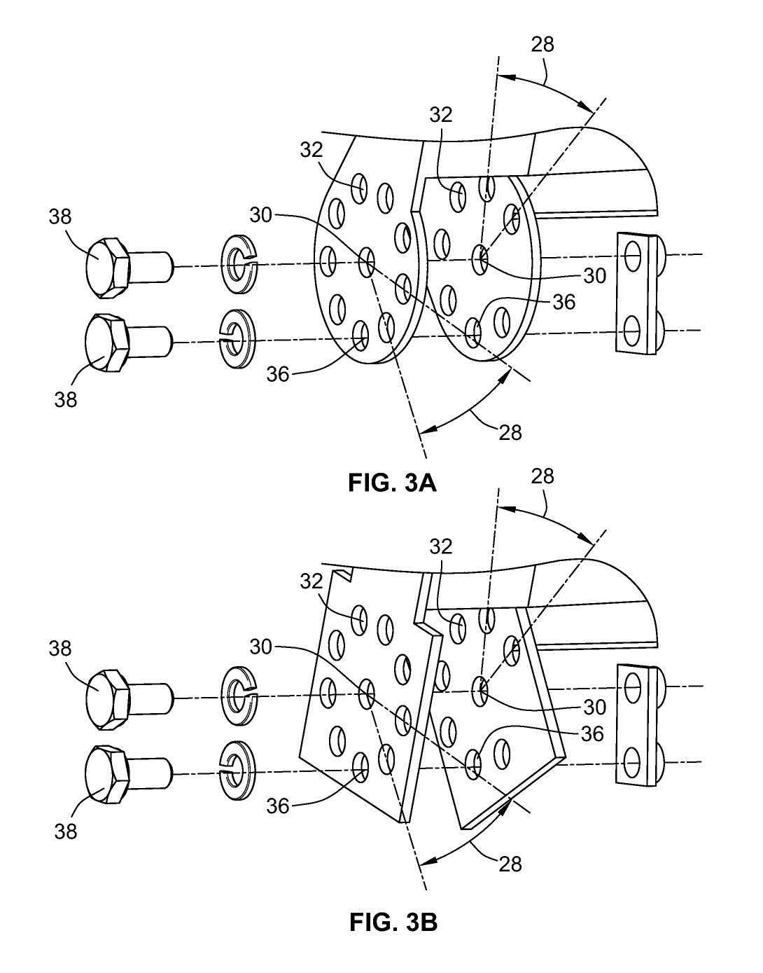

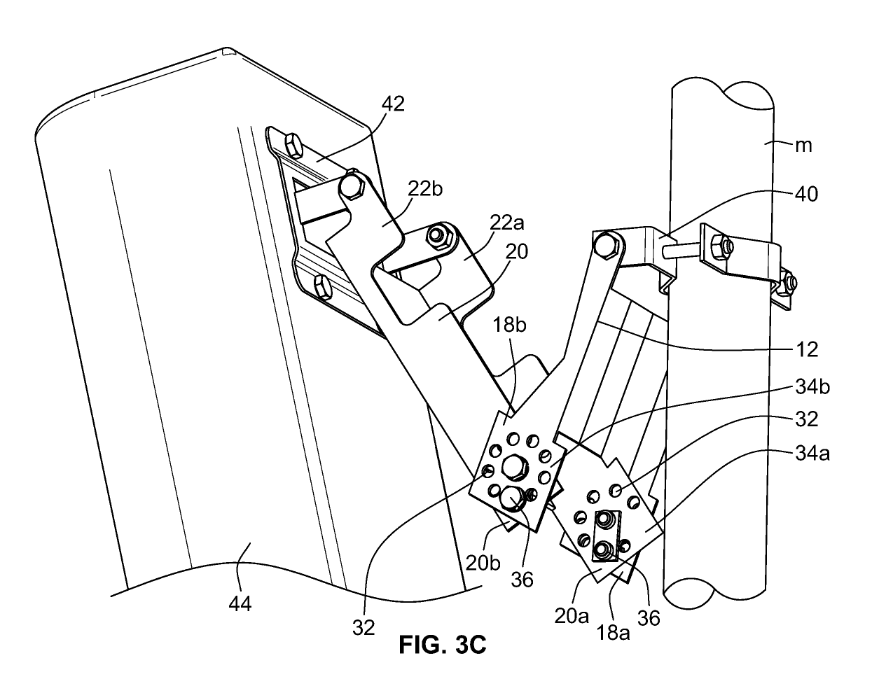

As shown in FIGS. 2 and 3A-C, both the extension flange hinge tabs 18a, 18b and the downtilt flange hinge tabs 26a, 26b have an axis point 30 and a plurality of apertures 32 uniformly spaced from one another in an arcuate or annular formation around at least a portion of the axis point 30. According to various embodiments, the extension flange hinge tabs 18a, 18b and the downtilt flange hinge tabs 26a, 26b can have a generally-circular shape or can have alternative shapes as desired. In addition, the axis point 30 can be centrally-located on the extension flange hinge tabs 18a, 18b or the downtilt flange hinge tabs 26a, 26b. Alternatively, the axis point 30 of the extension flange hinge tabs 18a, 18b or the downtilt flange hinge tabs 26a, 26b can be located in an off-center position.

As shown in the figures, each of the plurality of apertures 32 may be uniformly spaced from the respective axis point 30 at a substantially equal radial distance. Further, adjacent apertures along the extension flange hinge tabs 18a, 18b and the downtilt flange hinge tabs 26a, 26b are spaced from one another at an angle 28 relative the axis point 30. According to various embodiments, the spacing between apertures 32 on the extension flange hinge tabs 18a, 18b may be substantially uniform. Additionally, the spacing between apertures 32 on the downtilt flange hinge tabs 26a, 26b is also substantially uniform. However, the spacing between apertures on the extension flange hinge tabs 18a, 18b is preferably different than the spacing between apertures on the downtilt flange hinge tab 26a, 26b. Accordingly, the angle 28 between adjacent apertures on the downtilt flange hinge tabs 26a, 26b is different from the angle 28 between adjacent apertures on the extension flange hinge tabs 18a, 18b.

As shown in FIGS. 1A, 2 and 3A-C, the extension flange hinge tabs 18a, 18b and the downtilt flange hinge tabs 26a, 26b form a plurality of revolving nutplate hinges 34a, 34b coupling the extension member 12 to the downtilt member 20. Each of the plurality of nutplate hinges 34a, 34b is formed by an extension flange hinge tab 18a, 18b engaging a downtilt flange hinge tab 26a, 26b such that the axis point 30 of the extension flange hinge tab 18a, 18b is coaxially aligned with the axis point 30 of the downtilt flange hinge tab 26a, 26b. As is shown in the figures, the downtilt flange hinge tabs 26a, 26b may be positioned inside the extension flange hinge tabs 18a, 18b such that the inside surface of the extension flange hinge tab 18a, 18b is flush against the outside surface of the downtilt flange hinge tab 16a, 26b. Alternatively, the according to various embodiments, the downtilt flange hinge tabs 26a, 26b may be positioned outside the extension flange hinge tabs 18a, 18b such that the outside surface of the extension flange hinge tab 18a, 18b is flush against the inside surface of the downtilt flange hinge tab 26a, 26b.

Each nutplate hinge 34a, 34b can form a plurality of adjustment features 36. The adjustment features 36 are formed by rotating the downtilt member 20 to co-axially align an aperture 32 on the extension flange hinge tab 18a, 18b with an aperture 32 on the downtilt flange hinge tab 16a, 26b. Each adjustment feature 36 is suitable for accepting a fastener 38 for securing the revolving nutplate hinge 34 in a fixed position. According to certain embodiments, each nutplate hinge 34 is secured in a fixed position by at least two threaded fasteners 38a, 38b. A first threaded fastener 38a may be affixed through the co-axially aligned axis point 30 of an extension flange hinge tab 18a, 18b and the axis point 30 of a downtilt flange hinge tab 26a, 26b. A second threaded fastener 38b may be affixed through co-axially aligned apertures 32 of the extension flange hinge tab 18a, 18b and the downtilt flange hinge tab 26a, 26b. However, persons of ordinary skill in the art will understand that alternative numbers or arrangements of fasteners 38 may be used to secure the nutplate hinges 34a, 34b without departing from the novel scope of the present invention.

The different spacing between apertures 32 on the extension flange hinge tabs 18a, 18b and the spacing between apertures 32 on the downtilt flange hinge tabs 26a, 26b enable various adjustment features 36 to be formed by only slight movement of the downtilt member 20 relative the extension member 12. As a result of this arrangement, the mounting assembly 10 can be adjusted to any one of a plurality of highly-discrete positions across the range of angular rotation. Specifically, for a given number n of apertures 32, uniformly radially distributed about the axis point of the extension flange hinge tab 18a, 18b and downtilt flange hinge tab 26a, 26b, angular resolution, R, is defined by:

R=360/(n*n)

It will be further understood that the number of apertures 32 on either the extension flange hinge tabs 18a, 18b or the downtilt flange hinge tabs 16a, 26b can be varied. The number of apertures n will determine the angular resolution of the downtilt member 20. Specifically, a revolving nutplate hinge 34 allows for n/2 revolutions that provide (n*n)/2 discrete downtilt settings across the 180 degree bracket extension span. This unique sequence minimizes flange size because the adjustment features 36 are confined to the hinge tabs of the downtilt member 20 and the extension member 12. The novel arrangement of the adjustment features 36 will also minimize the impact to downtilt member strength.

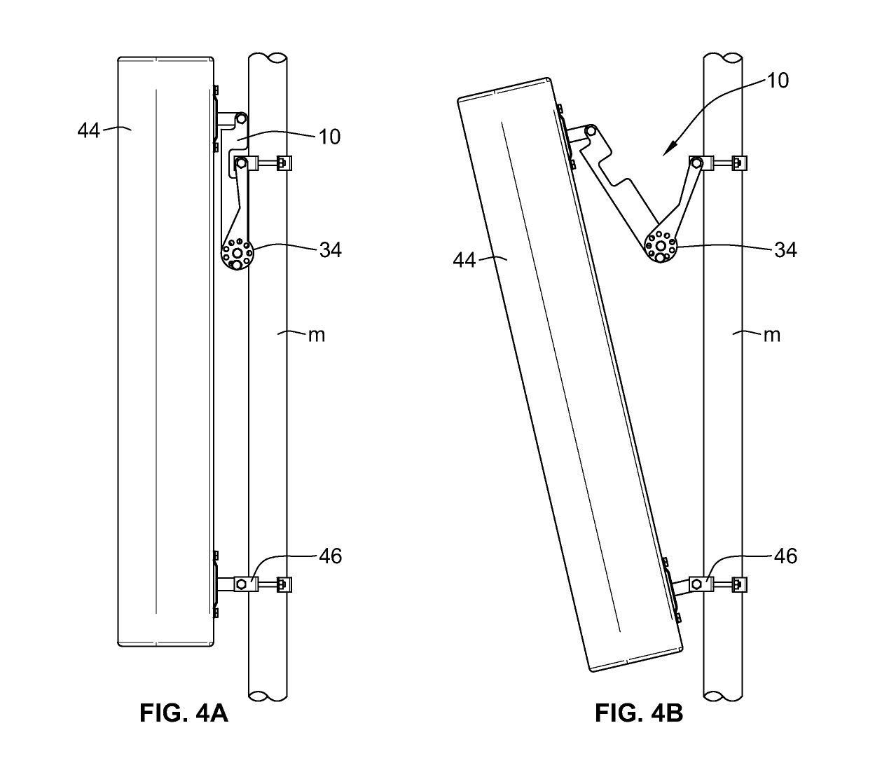

FIGS. 4a and 4b show an antenna mounting assembly 48 affixed to a mounting surface m. FIG. 4a shows the rotating mounting assembly 10 is in a closed position and the antenna assembly 44 substantially parallel to the mounting surface m. FIG. 4b shows the rotating mounting assembly 10 in an extended position. In this position, the antenna assembly 44 is mounted at an angle relative the support structure such that the beam of the antenna is tilted downward and is directed towards a particular area below the location where the antenna assembly 44 is mounted. In this position, the antenna assembly 44 can be more effective in transmitting and receiving electromagnetic signals from the particular area that the antenna is now directed towards.

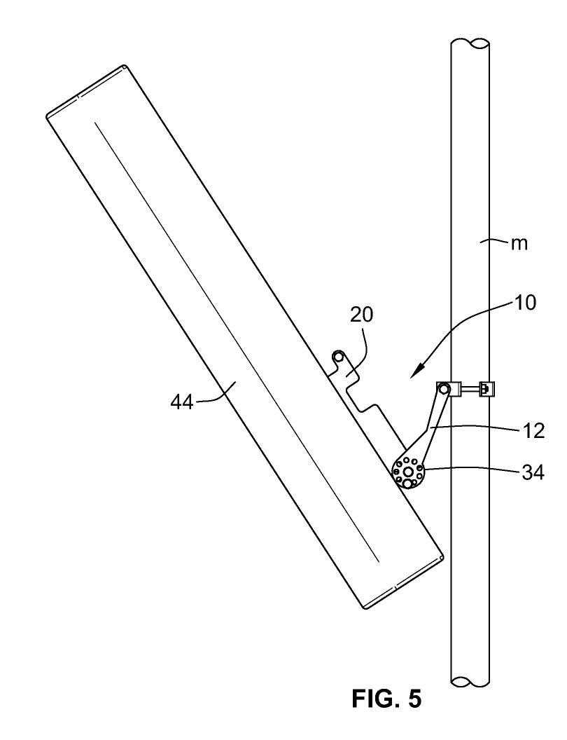

FIG. 5 shows an alternative embodiment for affixing the antenna assembly 44 to the mounting assembly 10. In this embodiment, the antenna assembly 44 is fastened directly to the support plate 24 of the downtilt member 20 such that no additional antenna bracket is required.

What is claimed is:

1. A rotating mounting assembly, comprising:
an extension member formed by two opposing extension flanges, each extension flange having an inside surface, an outside surface, and a proximal and distal end, each extension flange having a hinge tab at the distal end;
a downtilt member formed by two opposing downtilt flanges, each downtilt flange having an inside surface, an outside surface, and a proximal and distal end, each downtilt flange having a hinge tab at the distal end;
the extension flange hinge tabs and the downtilt flange hinge tabs each having an axis point and a plurality of apertures uniformly spaced from one another in an arcuate formation around at least a portion of the axis point, each of the plurality of apertures being spaced from the axis point at a substantially equal radial distance, adjacent apertures spaced from one another at an angle relative the axis point, the angle between adjacent apertures on the downtilt flange hinge tabs being different from the angle between adjacent apertures on the extension flange hinge tabs;
a plurality of revolving nutplate hinges coupling the extension member to the downtilt member such that the downtilt member rotates about the nutplate hinges relative to the extension member, each nutplate hinge formed by an extension flange hinge tab and a downtilt flange hinge tab engaging one another such that the axis point of the extension flange hinge tab is coaxially aligned with the axis point of the downtilt flange hinge tab, each nutplate hinge having a plurality of adjustment features formed by rotating the downtilt member to co-axially align an aperture on the extension flange hinge tab with an aperture on the downtilt flange hinge tab, the plurality of adjustment features suitable for accepting a fastener for securing the revolving nutplate hinge in a fixed position.

2. The mounting assembly of claim 1, wherein the downtilt member is adapted to rotate 180 degrees about the revolving nutplate hinges relative the extension member.

3. The mounting assembly of claim 1, wherein the assembly has an angular resolution, R determined by a number, n of adjustment features of a revolving nutplate hinge, such that
R=360/(n*n).

4. The mounting assembly of claim 1, wherein the extension member has a back plate extending substantially perpendicular between the extension flanges.

5. The mounting assembly of claim 1, wherein the downtilt member has a support plate extending substantially perpendicular between the downtilt flanges.

6. The mounting assembly of claim 1, wherein the plurality of nutplate hinges are formed such that the inner surface of the extension flange hinge tabs are flush against the outer surface of a downtilt flange hinge tab.

7. The mounting assembly of claim 1, wherein the plurality of nutplate hinges are formed such that the outer surface of the extension flange hinge tabs are flush against the inner surface of a downtilt flange hinge tab.

8. The mounting assembly of claim 1, wherein the hinge tabs of the downtilt flanges are generally circular in shape.

9. The mounting assembly of claim 1, wherein the hinge tabs of the extension flanges are generally circular in shape.

10. The mounting assembly of claim 1 further comprising a mounting bracket suitable for affixing the mounting assembly to a mounting surface, the mounting bracket affixed to the proximal end of each extension flange.

11. The mounting assembly of claim 1 further comprising an antenna bracket suitable for affixing an antenna assembly to the mounting assembly, the antenna bracket affixed to the proximal end of the downtilt flanges.

12. The mounting assembly of claim 1, wherein each revolving nutplate hinge is secured in a fixed position by at least two threaded fasteners, a first fastener affixed through the co-axially aligned axis points of the extension flange hinge tab and the downtilt flange hinge tab, a second fastener affixed through co-axially aligned apertures of the extension flange hinge tab and the downtilt flange hinge tab.

13. The mounting assembly of claim 13, wherein the support plate of the downtilt member is suitable for affixing an antenna assembly to the apparatus.

14. A mounting assembly, comprising:
an extension member formed by two substantially parallel opposing extension flanges and a back plate extending substantially perpendicular between the extension flanges, each extension flange having an inside surface, an outside surface, and a proximal and distal end, each extension flange having a generally circular hinge tab at the distal end;
a downtilt member formed by two substantially parallel opposing downtilt flanges and a support plate extending substantially perpendicular between the downtilt flanges, each downtilt flange having an inside surface, an outside surface, and a proximal and distal end, each downtilt flange having a generally circular hinge tab at the distal end;
the extension flange hinge tabs and the downtilt flange hinge tabs each having a centrally-located axis point and a plurality of apertures uniformly spaced from one another in an annular formation around the axis point, each of the plurality of apertures having a substantially uniform diameter and being spaced from the axis point at a substantially equal radial distance, adjacent apertures spaced from one another at an angle relative the axis point, the angle between adjacent apertures on the downtilt flange hinge tab being different from the angle between adjacent apertures on the extension flange hinge tab;
a plurality of revolving nutplate hinges coupling the extension member to the downtilt member such that the downtilt member rotates about the nutplate hinges relative to the extension member, each nutplate hinge formed by an extension flange hinge tab and a downtilt flange hinge tab engaging one another such that the inside surface of an extension flange hinge tab is flush against the outside surface of a downtilt flange hinge tab such that the axis point of the extension flange hinge tab is coaxially aligned with the axis point of the downtilt flange hinge tab, each nutplate hinge having a plurality of adjustment features formed by rotating the downtilt member to co-axially align an aperture on the extension flange hinge tab with an aperture on the downtilt flange hinge tab, the plurality of adjustment features suitable for accepting a fastener for securing the revolving nutplate hinge in a fixed position.
a mounting bracket suitable for affixing the assembly to a mounting surface, the mounting bracket affixed to the proximal end of each extension flange; and
an antenna bracket suitable for affixing an antenna assembly to the mounting assembly, the antenna bracket affixed to the proximal end of the downtilt flanges.

15. The mounting assembly of claim 14, wherein the downtilt member is adapted to rotate 180 degrees about the revolving nutplate hinges relative the extension member.

16. The mounting assembly of claim 14, wherein the assembly has an angular resolution, R determined by a number, n of adjustment features of a revolving nutplate hinge, such that
R=360/(n*n).

17. The mounting assembly of claim 14, wherein each revolving nutplate hinge is secured in a fixed position by at least two threaded fasteners, a first fastener affixed through the co-axially aligned axis points of the extension flange hinge tab and the downtilt flange hinge tab, a second fastener affixed through co-axially aligned apertures of the extension flange hinge tab and the downtilt flange hinge tab.

18. An antenna mounting apparatus, comprising:
a downward tilting mounting assembly having
an extension member formed by two substantially parallel opposing extension flanges and a back plate extending substantially perpendicular between the extension flanges, each extension flange having an inside surface, an outside surface, and a proximal and distal end, each extension flange having a generally circular hinge tab at the distal end;
a downtilt member formed by two substantially parallel opposing downtilt flanges and a support plate extending substantially perpendicular between the downtilt flanges, each downtilt flange having an inside surface, an outside surface, and a proximal and distal end, each downtilt flange having a generally circular hinge tab at the distal end;
the hinge tabs of both the extension flanges and downtilt flanges each having a centrally-located axis point and a plurality of apertures uniformly spaced from one another in an annular formation around the axis point, each of the plurality of apertures having a substantially uniform diameter and being spaced from the axis point at a substantially equal radial distance, adjacent apertures spaced from one another at an angle relative the axis point, the angle between adjacent apertures on the downtilt flange being different from the angle between adjacent apertures on the extension flange,
a plurality of revolving nutplate hinges coupling the extension member to the downtilt member such that the downtilt member rotates about the nutplate hinges relative to the extension member, each nutplate hinge formed by an extension flange hinge tab and a downtilt flange hinge tab engaging one another such that the inside surface of an extension flange hinge tab is flush against the outside surface of a downtilt flange hinge tab such that the axis point of the extension flange hinge tab is coaxially aligned with the axis point of the downtilt flange hinge tab, each nutplate hinge having a plurality of adjustment features formed by rotating the downtilt member to co-axially align an aperture on the extension flange hinge tab with an aperture on the downtilt flange hinge tab, the plurality of adjustment features suitable for accepting a fastener for securing the revolving nutplate hinge in a fixed position.
a mounting bracket suitable for affixing the assembly to a mounting surface, the mounting bracket affixed to the proximal end of each extension flange;
an antenna bracket suitable for affixing an antenna assembly to the mounting assembly, the antenna bracket affixed to the proximal end of the downtilt flanges.
an antenna assembly suitable for transmitting or receiving electromagnetic signals, the antenna assembly having an elongated body with a first end and a second end, the antenna bracket affixed to a point proximate the first end of the antenna assembly such that when the downtilt member rotates away from the extension member, the first end of the antenna assembly extends away from the mounting surface; and
a hinged support bracket suitable for securing the second end of the antenna assembly to the mounting surface, the support bracket having a hinged connection enabling the second end of the antenna assembly to pivot when the downtilt member of the mounting assembly rotates away from the extension member.

19. The antenna assembly of claim 18, wherein the downtilt member is adapted to rotate 180 degrees about the revolving nutplate hinges relative the extension member.

20. The antenna assembly of claim 18, wherein the downward tilting mounting assembly has an angular resolution, R determined by a number, n of adjustment features of a revolving nutplate hinge, such that
R=360/(n*n).

21. The antenna assembly of claim 18, further comprising at least one additional downward tilting mounting assembly affixed proximate the first end of the antenna assembly, the at least one additional mounting assembly adapted to further support the first end of the antenna assembly.
